(19) United States
(12) Patent Application Publication
(10) Pub. No.: US 2003/0091161 A1
(43) Pub. Date: May 15, 2003

(54) Dictation memo in telecommunication network

(76) Inventor: Rauli Tuominen, Hameenkyro (FI)

Correspondence Address: BROOKS & KUSHMAN, 1000 TOWN CENTER 22ND FL, SOUTHFIELD, MI, 48075

(21) Appl. No.: 10/275,376

(22) PCT Filed: May 3, 2001
(86) PCT No.: PCT/FI01/00422

(51) Int. Cl. H04M 1/64

(52) U.S. Cl. 379/68

(57) ABSTRACT

A method of saving a dictation message in a telecommunications system, comprising at least one terminal and subscriber-specific voice mailbox service, to which the calls are directed on the basis of the subscriber-specific voice mailbox service number. In the method, a dictation memo number and a terminal subscriber number responsive thereto are defined, and the calls incoming to the dictation memo number are directed directly into the message save mode of the voice mailbox service if the subscriber number of the incoming call is a terminal subscriber number responsive to the dictation memo number. The dictation memo number can be a subscriber-specific number or a general abbreviated number. If the subscriber number of the incoming call is not a terminal subscriber number responsive to the dictation memo number the calls incoming to the dictation memo number are directed via a recorded greeting message into the message save mode of the voice mailbox service. A call to the dictation memo number can be set up in the middle of the first call as an intermediate call, whereby the first call is put on hold.

### BACKGROUND OF THE INVENTION

The invention relates to the implementation of a dictation memo in a telecommunications network.

Both public land mobile networks and traditional public switched telephone networks presently provide users with several different operator-specific value added services, such as intelligent call forwarding and congestion, subscriber-specific service numbers, implementation of a ‘home call’, a virtual private network (VPN), which enables the use of abbreviated numbers between subscribers in the same private network, and a personal number, in which the calls to a personal number are re-routed in the manner controlled by the subscriber. The rapid increase in value added services has been enabled by the introduction of different intelligent network (IN) solutions in connection with telecommunications networks, i.e. both wired networks and mobile telephone networks. Said value added services can be implemented by intelligent networks in such a way that the implementation of services as such does not have to be according to a particular standard. This is achieved by separating the logical parts of the system implementing the call switching and value added service from each other. Value added services can naturally be implemented with a technique other than intelligent networks.

One value added service widely used is a voice mailbox service, in which the subscriber has a telephone answering machine implemented in the network, a connection being set up to the answering machine by means of a separate telephone number. Thus, the subscriber can implement call forwarding to the voice mailbox number for the calls incoming to his/her own number when, for example, his/her own number is engaged or, as regards a mobile station, when the mobile station is not in the network area. In this way, the incoming calls are directed to the voice mailbox, to which the caller can leave a voice message, the subscriber being able to listen to the message later on by calling the voice mailbox number.

Also known is a wake-up service, in which the subscriber can order a wake-up call at a desired time by calling a certain service number. A reminder alarm can also be connected to the wake-up service in such a way that when calling said service number, the subscriber can dictate a short message to himself/herself, which message is repeated to the subscriber in connection with the wake-up call.

The problem in prior art solutions is that when calling from his/her own subscriber number, the subscriber cannot dictate his/her messages into memory nor listen to them at a desired time. Neither is it possible to dictate the subscriber's own messages in the middle of a call. In order to be able to make notes during a call, the subscriber must typically have a pen and paper, a separate electronic memo or a dictating machine, by means of which notes can be made. However, when driving a car, for instance, it is difficult and dangerous to make notes, particularly in the middle of a call. In particular, it is laborious for people who move around a lot to transport note-making means, such as a separate dictating machine, with them.

### BRIEF DESCRIPTION OF THE INVENTION

An object of the invention is to provide a method and an apparatus implementing the method in such a way that above problems can be solved. The objects of the invention are achieved with a method and a terminal device which are characterized by what is stated in the independent claims. The preferred embodiments of the invention are disclosed in the dependent claims.

The invention is based on the idea that an existing voice mailbox service is utilized by defining a separate dictation memo number for the dictation memo service and a terminal subscriber number responsive thereto and directing the calls to the dictation memo number directly into the message save mode in the voice mailbox service if the subscriber number of the incoming call is a terminal subscriber number responsive to the dictation memo number. The dictation memo number can be a subscriber-specific number or a general abbreviated number. If the subscriber number of the incoming call is not a terminal subscriber number responsive to the dictation memo number, the calls to the dictation memo number are directed via a recorded greeting message into the message save mode in the voice mailbox service. A call to the dictation memo number can be set up as an intermediate call in the middle of the first call, in which case the first call is put on hold.

An advantage of the method according to the invention is that dictation memo numbers allow the calls incoming to the voice mailbox service to be directed preferably directly into the recording mode, in which case the caller can immediately dictate the message to himself/herself and listen to it later at a suitable time. The implementation of the dictation memo service preferably utilizes the infrastructure of an existing voice mailbox service. Further, the advantage of a preferred embodiment of the invention and terminal device according to the invention is that a connection can be set up in the dictation memory service in the middle of a call by putting the first call on hold and calling the dictation memo number. Thus, it is not necessary to make notes on paper when driving a car, for example, which improves road safety. Still further, the advantage of a preferred embodiment of the invention is that the intermediate call set up in the dictation memo can be connected to a conference call, whereby the discussion of the conference call is saved in the memory of the dictation memory service.

### BRIEF DESCRIPTION OF THE DRAWINGS

The invention will now be described in more detail in connection with preferred embodiments of the invention, with reference to the attached drawings, of which

FIG. 1 shows a simplified block diagram of the structure of a typical intelligent network used for implementing value added services;

FIG. 2 shows simplified implementation of a dictation memo service according to the invention in connection with a typical voice mailbox service; and

FIG. 3 shows a flowchart of an implementation model of a dictation memo service according to the invention.

### DETAILED DESCRIPTION OF THE INVENTION

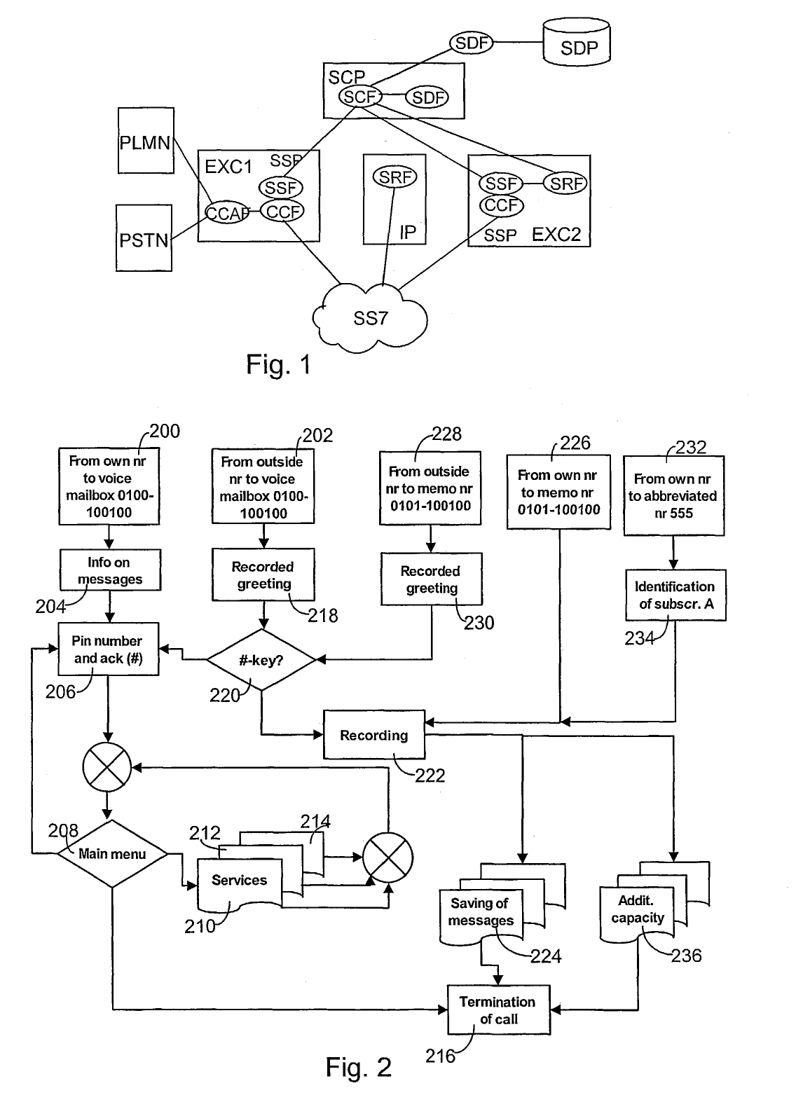

With reference to FIG. 1, the following describes the structure of an intelligent network as one feasible implementation environment according to the invention. Although it is preferable to implement the invention specifically by means of intelligent networks, utilizing existing network infrastructures, the implementation of the method is not confined to the intelligent network environment. The invention can also be implemented merely by means of a logic built in connection with a telephone network.

The basic call state model BCSM of the call defined in connection with an intelligent network expresses the different stages of call control and contains the points where the call control can be interrupted to start a service of the intelligent network. It recognizes those detection points in the call and connection process where the service logic entities of the intelligent network can interact with the basic call and connection control properties.

Typically, one or more service control functions, SCF, are connected to the intelligent network architecture. The name ‘service control point’, SCP, is used for an apparatus or network element that performs the tasks defined for the SCF, the SCP being thus a system element implementing a value added service. The SCP gives call set-up instructions to the exchange EXC, or the exchange can request call set-up instructions from it. If, for instance, it is observed at some stage of the call set-up that the connection of the subscriber B is engaged, the call can be directed to an alternative number, such as a voice mailbox number. FIG. 1 also shows other elements of the intelligent network, such as a call control function (CCF), which comprises the high-level call processing functions of an exchange EXC1, EXC2, for instance the set-up and release of transmission links. A service data function SDF and a service data point SDP form a database containing subscriber- and/or service-specific information. A specialized resource function SRF is an interface for the network mechanisms relating to interaction with the subscriber. It can also relate to what are called intelligent peripherals (IP) containing for example speech processing functions more advanced than exchanges in general. The elements of the intelligent network communicate with each other via a network based on the SS7 (Signalling System 7) protocol.

A service switching function (SSF) is an interface between the call control function CCF and the service control function SCP. The network element performing the SSF function is called a service switching point (SSP). At least one service switching point is typically implemented in connection with the exchange of a telephone network, which exchange can be, as mentioned, a public land mobile network (PLMN) or a traditional public switched telephone network (PSTN). The intelligent network service is provided in such a way that when encountering the detection points relating to services, the service switching point SSP requests instructions from the service control point SCP by means of messages transmitted over the SSP/SCP interface. In the intelligent network terminology, these messages are called operations. In connection with the intelligent network service, a service program is started at the service control point SCP, the function of the program determining those operations that the SCP sends to the SSP in each call phase.

FIG. 2 shows a flowchart of a simplified implementation of a dictation memo service according to the invention in connection with a typical voice mailbox service. The voice mailbox service, the number of which is in this example 0100-100 100, can be typically contacted in two different ways; calling said voice mailbox number either from the subscriber's own subscriber number (200) or from an outside subscriber number (202). If the call is made from the subscriber's own subscriber number, the voice mailbox service typically informs the subscriber on the messages left and instructs the subscriber to listen to the messages (204). The subscriber can be identified either automatically on the basis of the subscriber number of the calling subscriber (subscriber A), or the subscriber can be requested to key in a personal identification number and press an acknowledgement key, such as the key # (206). The identification (206) of the subscriber and a notification of the messages left (204) can also be made in the opposite order.

The next step is the main menu (208) of the voice mailbox service, from which the identification (206) of the subscriber can be attempted once more if the authentication has failed. If the authentication is successful, one can move on to different services (210, 212, 214) of the voice mailbox, which services can comprise listening to the messages, saving and deleting messages, changes in the settings of the voice mailbox service, and different service instructions, which all have feedback to the main menu (208). From the main menu, the call can also be terminated (216). It is to be noted that when the call is made from the subscriber's own subscriber number, the recording mode (222), in which the caller could leave a message to the voice mailbox, cannot typically be achieved.

If the voice mailbox service is called from an outside subscriber number (202), the service is directed into a mode in which the caller is provided with a recorded greeting message (218). If subscribing to this voice mailbox service, the caller can listen to the messages left by pressing an acknowledgement key, such as the key # (220), during the greeting message, whereby the call is directed to the identification block (206) described above, from which one moves on via the successful authentication to the main menu (208) of the voice mailbox service in the manner described above. If, by contrast, the caller is not a subscriber to this voice mailbox service and thus does not intend to listen to the messages by pressing the acknowledgement key (220) during the greeting message, the call is directed into the message recording mode (222), of which a notification is typically given with an acoustic signal. After this, the caller can leave a voice message (224) for the subscriber to the voice mailbox, said subscriber being able to listen to the message later on in the way described above. After leaving the message, the call is terminated (216).

Now, in accordance with a preferred embodiment of the invention, a ‘memo number’ is defined for the subscriber, in this example 0101-100 100. The memo number allows a dictation memo service according to the invention to be implemented in a preferred manner in connection with the voice mailbox service described above. Also the subscriber's own memo number can be called from either the subscriber's own subscriber number (226) or from an outside subscriber number (228). When the subscriber's own memo number is called from the subscriber's own subscriber number, the telecommunications system, preferably the intelligent network connected thereto, is arranged to identify the caller (subscriber A) and to direct the call directly into the recording mode (222) of the voice mailbox service, of which a notification is preferably given with an acoustic signal. Several subscriber numbers, for instance a mobile telephone number and a wired telephone number, can be defined for the user of the service, the system identifying these numbers as what are called the user's own subscriber numbers. When calling the memo number from an outside subscriber number, the caller is provided with a recorded greeting message (230) of the dictation memo service. If subscribing to said voice mailbox service, the caller can move on to the main menu (208) of the voice mailbox service by pressing the acknowledgement key (220) during the greeting message and authenticating the subscriber in the identification block (206). By contrast, if the caller wishes to leave a dictation message in the voice mailbox, the call is directed after a short delay into the message recording mode (222), of which a notification is typically given with an acoustic signal. After this, the caller can dictate the voice message (224) to be saved, which can be listened to later on, as described above. After the message has been left, the call is terminated (216). The dictation memo/voice mailbox service can preferably comprise additional capacity (236) to save several or long dictation messages.

According to a preferred embodiment of the invention, the memo number can be implemented as an operator-specific nation-wide abbreviated number, in which case, when the call is made from the subscriber's own subscriber number, the call is directed to the correct dictation memo/voice mailbox service on the basis of the identification of the subscriber A performed in the network. When, for example, the subscriber calls said abbreviated number, in the example 555, from his/her own mobile station (232), identification (234) of the subscriber A is performed either in a public land mobile network or in an intelligent network connected thereto. On the basis of the identification of the subscriber A, it is checked, preferably in the intelligent network, whether the dictation memo service of the particular subscriber is activated; if it is, the call is directed directly into the message recording mode (222), of which a notification is given preferably with an acoustic signal. If the dictation memo service is not activated, the caller is given an error message.

Now, the calls incoming to the voice mailbox service can be directed preferably directly into the message recording mode, in which case the caller, typically a subscriber to the dictation memo/voice mailbox service, can immediately dictate the message to himself/herself and then listen to it later on at a desired time. The number of the dictation memo preferably differs from the number of the voice mailbox service, whereby a connection can be set up in the middle of a call by putting the first call on hold and calling the memo number. Thus, the matters brought up during the first call can be dictated to be saved in the memory, and one can return to the first call. In this way, it is not necessary to make notes on paper when driving a car, for example, which improves road safety.

In accordance with a preferred embodiment, a call to the dictation memo service can be connected to what is called a conference call or a multi-party call. Modern telephone systems, such as mobile communication systems, comprise a conference call function, which enables a call between several parties, in which all parties can hear the conversation and participate in it. A one-to-one call can be changed to a conference call, and more parties can be brought to participate in the call. A call set up in the memo number can also preferably be connected to a conference call as one call, in which case the recording function stores the conversation during the conference call, which functions as some kind of conference memo. In connection with long conference calls, additional capacity (236) of the message storage is particularly advantageous.

Above-described services can be provided as an intelligent network service in such a way that certain detection points relating to the services are defined, in connection with the encounter of which points the service switching point SSP requests instructions from the service control point SCP by means of messages transmitted over the SSP/SCP interface. In connection with the intelligent network service, a service program is started at the service control point SCP, the function of which determines those operations that the SCP sends to the SSP at each call phase. Thus, calls from different subscriber numbers to either the memo number or the voice mailbox number function as detection points, each of which starts a different service program.

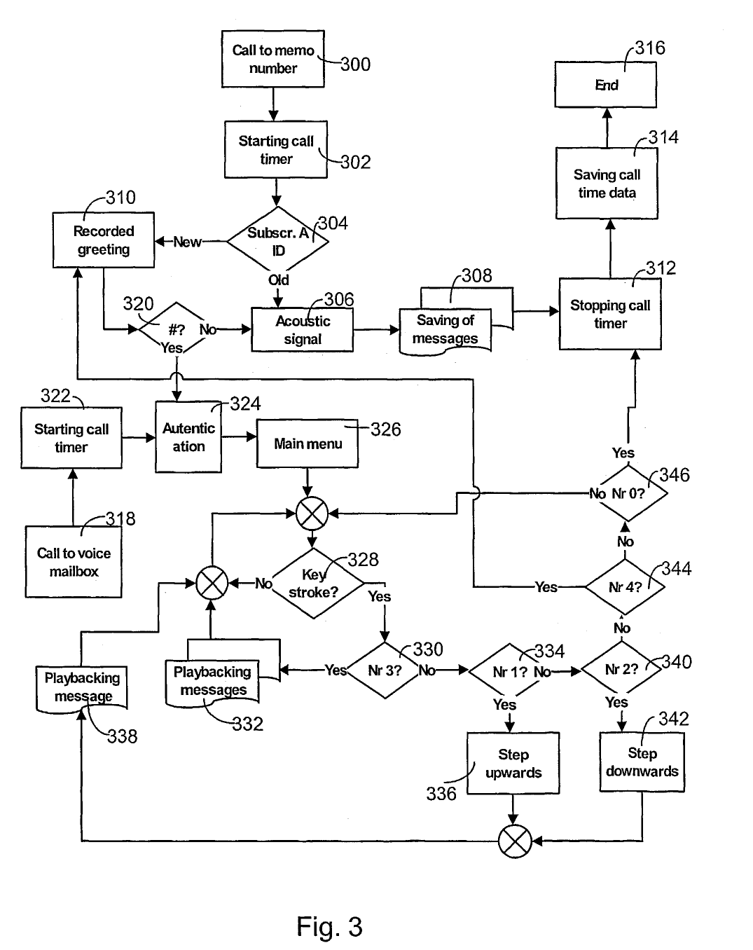

FIG. 3 shows a flowchart of an implementation method of the dictation memo service according to the invention. The dictation memo service starts when the incoming call is directed to a memo number (300), a call timer (302) being started as a response thereto. Next, the caller is identified on the basis of the identifier of the subscriber A (304) in such a way that a call coming from what are called subscribers' own subscriber numbers is directed into a message recording mode (308) with an acoustic signal (306). A call coming from an outside subscriber number can also be directed into the message recording mode via a greeting message (310). After the saving of the message, the call timer is stopped (312), the call time data are saved in the system together with the identifier of the subscriber A (314), and the call is terminated (316).

The playback of the messages takes place either by means of the call (318) to the voice mailbox service, or it is possible to get into the message playback mode from the call to the memo number from an outside subscriber number described above by pressing the acknowledgement key (#) during the greeting message (320). The call to the voice mailbox service starts the call timer (322), after which authentication (324) of the subscriber is performed, as a response to which one gets to the main menu (326) of the combined dictation memo/voice mailbox service. The caller is provided with different control options for playing back the messages and changing the settings, for the performance of which control functions the caller has to press certain keys (328).

By pressing numeric key 3 (330), the caller can play back all saved messages successively (322). Numeric key 1 (334) enables scanning of messages upwards one by one (336), whereby only one message is played back (338). Correspondingly, numeric key 2 (340) enables scanning of messages downwards one by one (342). Numeric key 4 (344) allows modification of the recorded greeting message (310) or other settings. Numeric key 0 (346) starts the termination of the call, prior to which the call timer is stopped (312), the call time data is saved in the system together with the identifier of the subscriber A (314) and the call is terminated only after this (316). The keystrokes presented herein are only examples of how different functions can be controlled. The dictation memo/voice mailbox service can naturally also comprise many other functions that can be controlled either with keystrokes or for instance from a voice, menu or touch display in the terminal.

In accordance with one embodiment the terminal of a telecommunications network, such as a mobile station, is arranged to call the subscriber's memo number directly with one keystroke, i.e. shortcut key, also when the subscriber is in the middle of another call. Thus, pressing the shortcut key somewhat longer than normally puts the unfinished call on hold and connects the new call to the memo number, in other words the terminal is arranged to take the intermediate call as intercom dialling. This can be implemented in terminals either by means of intercom dialling related to a numeric key or with a separate memo key. Old terminals can be reprogrammed in such a way that a given numeric key always functions as intercom dialling of the memo number. As regards new terminals, the function can be introduced as early as in the manufacturing stage.

In accordance with one embodiment, the intercom dialling of the memo number as an intermediate call can also be implemented as menu control from the control menu of the terminal. Thus, it can preferably be selected from the menu whether an intermediate call is to be performed for the dictation of a message, or whether a conference call is to be recorded, whereby the terminal automatically directs the call to the dictation memo service to be connected to the conference call. This control function can also be performed as voice or touch display control.

Above, the invention has been described primarily as utilization of a dictation memo service performed as an intermediate call or a conference call. It is obvious for a person skilled in the art that the use of the service according to the invention does not require that the subscriber be in the middle of an unfinished call, but the memo number can be called at any time and the desired message can be dictated to oneself or to a particular recipient. This is advantageous particularly for people who move around a lot; now they do not have to carry separate note-making means with them but can dictate important matters to be saved in the memory, from which the dictation messages can later be listened to at a suitable time.

It is obvious for a person skilled in the art that as the technology advances, the basic idea of the invention can be implemented in several different manners. The invention and its embodiments are thus not confined to the above-described examples but can vary within the scope of the claims.

1. A method of saving dictation messages in a telecommunications system comprising at least one terminal and subscriber-specific voice mailbox service, to which the calls are directed on the basis of a subscriber-specific voice mailbox service number; characterized by
defining a dictation memo number and at least one terminal subscriber number responsive thereto and
directing the calls to said dictation memo number directly into the message save mode in said voice mailbox service as a response to the subscriber number of the incoming call being a terminal subscriber number responsive to the dictation memo number.

2. A method according to claim 1, characterized by defining the subscriber-specific number or a general abbreviated number as the dictation memo number.

3. A method according to claim 1, characterized by
directing the calls incoming to the dictation memo number via a recorded greeting message into the message save mode of said voice mailbox service as a response to the subscriber number of the incoming call not being a terminal subscriber number responsive to the dictation memo number.

4. A method according to any one of the preceding claims, characterized by
the call being set up to said dictation memo number in the middle of the first call as an intermediate call, as a response to which, said first call is put on hold.

5. A method according to claim 4, characterized by
connecting said intermediate call set up in the dictation memo number to the first call as a conference call and releasing the first call from hold, whereby the conference call is saved via said intermediate call.

6. A method according to any one of the preceding claims, characterized by
listening to the saved dictation messages via the main menu of the voice mailbox service by calling the subscriber-specific voice mailbox service number or dictation memo number from the terminal subscriber number of the terminal not responsive thereto.

7. A method according to any one of the preceding claims, characterized by
the main menu of the voice mailbox service comprising at least functions for listening to the messages successively or one by one, for changing the settings and for terminating the service, which functions are controlled by means of the terminal.

8. A method according to any one of the preceding claims, characterized by
the voice mailbox service comprising additional capacity reserved for the dictation memo service to save a dictation message.

9. A method according to any one of the preceding claims, characterized by
implementing the dictation memo service by means of an intelligent network.

10. A terminal of a telecommunications network, such as a mobile station, which comprises saving means for saving a telephone number in the memory and for connecting it to a particular shortcut key and which is arranged to set up a call to said telephone number as a response to the pressing of the shortcut key, characterized in that the terminal is arranged
to set up a call in the middle of the first call as an intermediate call to a second telephone number, such as a dictation memo number, and to put said first call on hold as a response to the pressing of said shortcut key.

11. A terminal according to claim 10, characterized in that the terminal comprises
means for connecting said intermediate call set up in said second telephone number to the first call as a conference call, and for releasing the first call from hold.

12. A terminal according to claim 11, characterized in that
said means comprise menu, voice or touch display control means.
